(19) United States
(12) Patent Application Publication
(10) Pub. No.: US 2026/0121741 A1
(43) Pub. Date: Apr. 30, 2026

(54) SYSTEMS AND METHODS FOR IMPROVING PERFORMANCE AND RELIABILITY OF A FIBER OPTIC NETWORK

(71) Applicant: Lumetec Inc., San Francisco, CA (US)

(72) Inventors: Zack Jack Spica, Ann Arbor, MI (US); Jorge Alberto Castillo Castellanos, Pasadena, CA (US); Valey Kamalov, Gainesville, FL (US)

(21) Appl. No.: 19/151,605

(22) PCT Filed: Apr. 29, 2025
(86) PCT No.: PCT/US2025/026908

§ 371 Date: Jul. 28, 2025

Related U.S. Application Data
(60) Provisional application No. 63/641,655, filed on May 2, 2024.

(51) Int. Cl. H04B 10/038; H04B 10/079; H04B 10/2569; H04B 10/27

(52) U.S. Cl. CPC H04B 10/038; H04B 10/07951; H04B 10/2569; H04B 10/27

(57) ABSTRACT

A method of improving performance and reliability of a target fiber optic network is described. The method comprises: (i) observing changes in polarization states (SoP) of light signals in a training fiber optic network; (ii) correlating flap events with a first subset of the changes in polarization states (SoP) of light signals that occur prior to the flap events in the training fiber optic network; (iii) identifying one or more distinct characteristics in the first subset of changes in polarization states in the training fiber optic network that indicate an occurrence of a flap event; (iv) detecting an occurrence of the one or more distinct characteristics in the target fiber optic network; and (v) rerouting network traffic in the target fiber optic network to preemptively avoid a flap event upon detecting the occurrence of the one or more distinct characteristics. Alternatively, the method can comprise correlating the non-occurrence of a flap event with changes in SoP to route network traffic.

### FIELD OF THE INVENTION

The field of the invention is optical telecommunications, more specifically, forecasting short-term outages, or flaps, in a fiber optic network to improve network performance and reliability.

### BACKGROUND

The background description includes information that may be useful in understanding the present invention. It is not an admission that any of the information provided herein is prior art or relevant to the presently claimed invention, or that any publication specifically or implicitly referenced is prior art.

Fiber optic networks are pivotal in global communication and are responsible for transmitting substantial volumes of data across the world through varied and complex environments. The unimpeded flow of light signals within fiber optic cables is core to the performance and reliability of fiber optic networks. Excessive movement of a fiber optic cable, such as bending, swaying, and stretching can temporarily impede the flow of light signals and cause flap events. As used herein, a flap event in a fiber optic network means a non-operational state of a route within the network due to impediment and/or disruption of the flow of light signals through the route. These flap events are typically temporary and self-restoring. In some cases, a flap event is a time period during which a route rapidly oscillates between operational and non-operational states.

Excessive movement of fiber optic cables commonly occurs during network maintenance. Since different internet service providers (ISPs) lay or install their fiber optic cables together along the same routes, the maintenance tasks of one ISP can affect the signals of other ISPs.

Excessive movement of fiber optic cables also commonly occurs due to environmental factors such as strong winds, seismic activity, lightening, storms, tides, and landslides. These environmental occurrences can affect the functioning of fiber optic networks by causing the cables to sway or vibrate, thereby disrupting the flow of light signals within the cables, leading to flap events and degrading the network's performance and reliability. Historically, monitoring network performance and detecting physical movements in fiber optic cables required complex, sensitive, and expensive equipment, external to standard telecom setups. For example, distributed acoustic sensing (DAS) has been used to analyze optical phase changes in light signals to assess the integrity of a fiber and potential related network issues. However, DAS requires specialized hardware like ultra-stable and/or high-powered lasers, which are not standard in current optical networks.

Thus, there is still a need for systems and methods of detecting excessive movements in fiber optic cables to forecast flap events in order to improve the performance and reliability of optical networks.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatuses, systems, and methods for improving performance and reliability of a target fiber optic network. In one embodiment, the method comprises (i) observing changes in the state of polarization (SoP) of light signals in a training fiber optic network; (ii) correlating short-term outages, or flap events, with a first subset of the changes in SoP of light signals that occur prior to the flap events in the training fiber optic network; (iii) identifying one or more distinct characteristics in the first subset of changes in SoP in the training fiber optic network that indicate an occurrence of a flap event; (iv) detecting an occurrence of the one or more distinct characteristics in the target fiber optic network; and (v) rerouting network traffic in the target fiber optic network to preemptively avoid internet customers experiencing flap events and service degradation.

The SoP of light in an optical link refers to the orientation and phase of the electromagnetic wave's electric field vector as it travels through the optical medium. Light waves can be polarized in various ways, with the most common states being linear, circular, and elliptical polarization. The SoP of light is crucial in many optical applications, including telecommunications, where it can be used to reduce crosstalk and enhance the capacity of optical links. SoP can be influenced by the properties of the optical link itself, such as fiber geometry and material birefringence, and can change due to external influences like temperature variations and mechanical stress.

In some embodiments, the training fiber optic network and the target fiber optic network are the same. However, it is also contemplated that the training fiber optic network and the target fiber optic network can be located in different geographical areas and/or operated by different internet service providers (ISP).

In other aspects, the method can further comprise the step of correlating non-occurrence of flap events with a second subset of changes in SoP of light signals in the training fiber optic network. By correlating changes in SoP with either the occurrence or non-occurrence of a flap event, the system can more accurately distinguish characteristics in changes in polarization states that are unique to flap events.

The changes in SoP of light signals can be caused by a physical movement of a fiber optic cable in the training fiber optic network, such as a bending, swaying, pulling, or stretching of the cable.

In yet other aspects, the method can further comprise the step of classifying one or more distinct characteristics in the first subset of changes in SoP as either an environmental change or a maintenance task.

In some embodiments, the method further includes the step of using AI to identify one or more distinct characteristics in the first subset of changes in polarization states in the training fiber optic network that indicate an occurrence of a flap event. The distinct characteristics can be a sequence of events or time series analysis (e.g., waveforms, frequencies) and location where outages occur.

It is also contemplated that the method can further comprise the step of utilizing performance data (e.g., outage logs or packet drops) to verify that one or more distinct characteristics in the first subset of changes in SoP in the training fiber optic network is indicative of an occurrence of a flap event.

In is further contemplated that methods may also include the step of adjusting or stopping a maintenance operation of either the target fiber optic network or a neighboring fiber optic network upon detecting the occurrence of the one or more distinct characteristics in the target fiber optic network.

In some embodiments, the method further includes the step of comparing a maintenance record of either the target fiber optic network or a neighboring fiber optic network with the changes in SoP.

In other aspects, methods can further comprise the step of mitigating the impact of long-term environmental changes on the SoP data from the training fiber optic network by rotating a Polarization's Stokes parameter of the light signals towards the north pole on the Poincaré sphere. It is also contemplated that the method can include the step of converting the rotated time series into frequency domain spectra and creating statistical models designed to identify physical events that impair network performance.

In yet other aspects, it is contemplated that the steps of detecting and rerouting can be performed in real-time.

The inventive subject matter also provides a method of improving performance and reliability of a target fiber optic network comprising: (i) observing changes in polarization states (SoP) of light signals in a training fiber optic network; (ii) correlating non-occurrence of a flap event with a first subset of the changes in polarization states (SoP) of light signals that occur prior to the non-occurrence of the flap event in the training fiber optic network; (iii) identifying one or more distinct characteristics in the first subset of changes in polarization states in the training fiber optic network that indicate a non-occurrence of a flap event; (iv) detecting an occurrence of the one or more distinct characteristics in a fiber optic cable of the target fiber optic network; and (v) routing network traffic through the fiber optic cable upon detecting the occurrence of the one or more distinct characteristics.

Various objects, features, aspects and advantages of the inventive subject matter will become more apparent from the following detailed description of preferred embodiments, along with the accompanying drawing figures, in which like numerals represent like components.

### BRIEF DESCRIPTION OF THE DRAWINGS

FIG. 1 is a diagram of a fiber optic cable.

FIG. 2 is a diagram of the monitoring of SoP and adjustment of the Stokes parameters of the Poincaré sphere.

FIG. 3 is a method of improving performance and reliability of a target fiber optic network.

FIG. 4 is a method of improving performance and reliability of a target fiber optic network.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed. Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

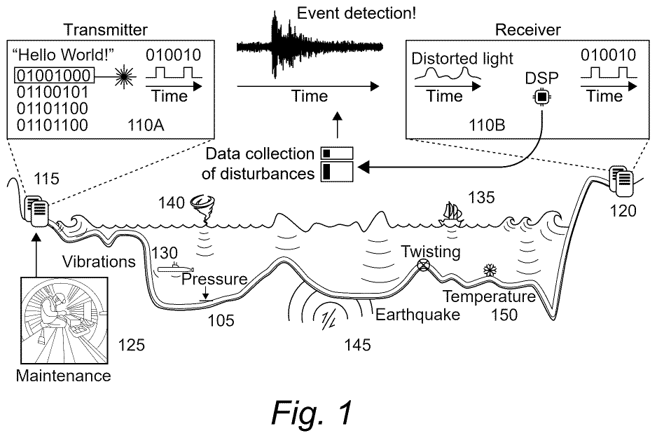

FIG. 1 is a diagram of an underwater fiber optic cable 105 being subjected to different stressors and physical disturbances. As a light signal 110a is transmitted from a transmitter 115 to a receiver 120, the state of polarization (SoP) of the light signal can change due to various sources of interactions with the cable. For example, FIG. 1 shows a maintenance worker 125 on the cable near the transmitter. FIG. 1 also shows one or more submarines 130, one or more ship engines 135, severe weather changes 140, earthquakes 145, and temperature fluctuations 150 from underwater volcanos. As signal 110a travels through fiber optic cable 105 from transmitter 115 to receiver 120, the SoP of signal 110a is converted into a different a signal 110b having a different SoP than 110a.

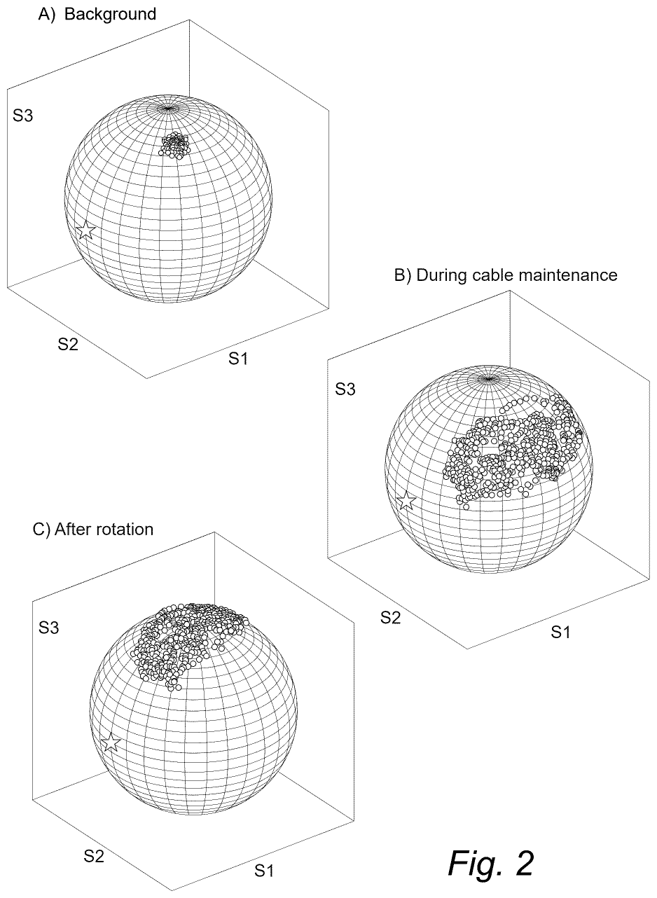

FIG. 2 illustrates the basic principles of SoP sensing. (A) Here, receiver 120 continuously tracks the SoP of the transmitted light 110a, depicted as blue dots on the Poincaré sphere, while the initial SoP remains unchanged (indicated by a red star). In this scenario, the output SoP is stable, reflecting minimal disruptions along most of the cable during calm periods. (B) Depicts the alteration of Stokes parameters during an event involving maintenance of terrestrial fiber cables, which are exposed to various stressors and physical disturbances. As the three Stokes parameters are normalized to 1.0, only two can vary independently. These parameters are adjusted to align with the north pole of the Poincaré sphere (C), with a focus on changes in the S1 and S2 parameters after this adjustment.

The inventive subject matter uses SOP sensing for the early detection of network flaps. SOP data from a training network can be used to generate statistical models of cable movements and disturbances. The models can identify distinct characteristics and/or patterns in cable movements that are indicative of the occurrence of a flap event.

In one example, models were generated by observing SOP data in a training network for a period of time. During that time, the Stokes parameters remained stable for a period longer than 24 hours but began fluctuating tens of minutes before a flap, likely due to fiber maintenance activities on a neighboring cable. This ability of SOP sensing to identify stress signatures akin to those caused by physical adjustments to the fiber allows for the development of routing algorithms that can reroute data traffic based on specific SOP disturbances, enhancing network reliability.

For the use case of preemptive rerouting, it is possible to develop algorithms capable of identifying events that trigger flaps. These algorithms can vary from basic anomaly detection methods, like Short-Term-Average to Long-Term-Average ratios (STA/LTA), to linear classifiers that utilize various features of the SoP waveform, including magnitude, duration, time-of-day, and frequency content of the disturbances. In one example, a linear classifier was designed to provide a minute-scale margin for real-time detection, indicating the potential for more sophisticated algorithms to improve flap prediction and facilitate preemptive traffic rerouting.

In one case example, a three-month period of observation and analysis revealed a strong correlation between the timing of network flaps and anomalous SOP events, with both peaking mid-week and tapering off towards the weekend. DAS data showed a similar trend. Hourly patterns across the datasets displayed peaks during early hours and midday, times commonly associated with high anthropogenic activities, supporting the hypothesis that most outages stem from human interventions on the fiber network.

After understanding how events can be detected and their main features, a machine learning algorithm can be built to automatically detect and classify these events.

Gathering optical measurements will now be explained. Many contemporary optical transceivers employ a polarimeter to record the Stokes parameters, mitigating polarization-dependent losses in the fiber. This process also supports demodulation in systems that use polarization-division multiplexing. Consequently, an exhaustive depiction of the light's SOP is inherently accessible to optical transceivers that are already in operation. These Stokes parameters are relayed to our telemetry backend at a mean sampling rate of 17 Hz.

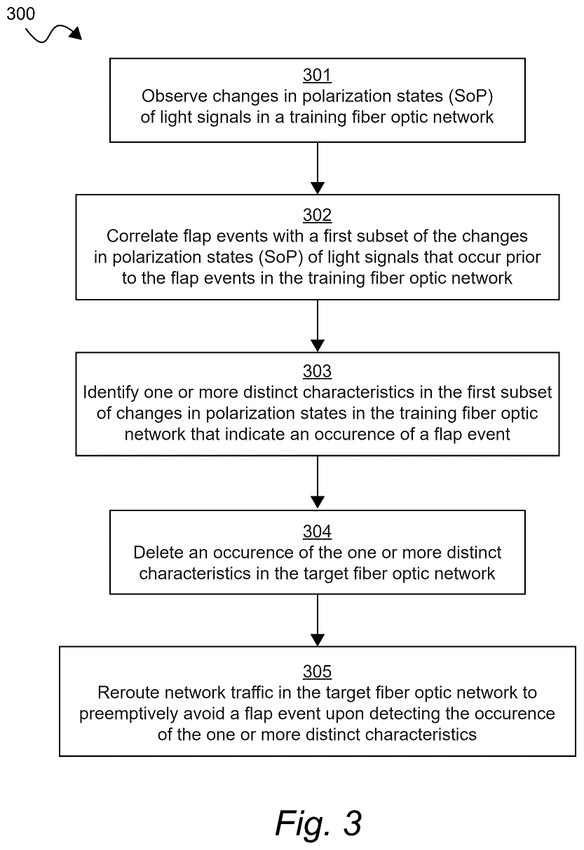

FIG. 3 shows a method 300 for improving performance and reliability of a target fiber optic network. Step 301 is to observe changes in polarization states (SoP) of light signals in a training fiber optic network. Step 302 is to correlate flap events with a first subset of the changes in polarization states (SoP) of light signals that occur prior to the flap events in the training fiber optic network. Step 303 is to identify one or more distinct characteristics in the first subset of changes in polarization states in the training fiber optic network that indicate an occurrence of a flap event. Step 304 is to detect an occurrence of the one or more distinct characteristics in the target fiber optic network. Step 305 is to reroute network traffic in the target fiber optic network to preemptively avoid a flap event upon detecting the occurrence of the one or more distinct characteristics. In this manner, network traffic can be preemptively rerouted away from fiber optic cables and pathways within the network that are likely to experience a flap event.

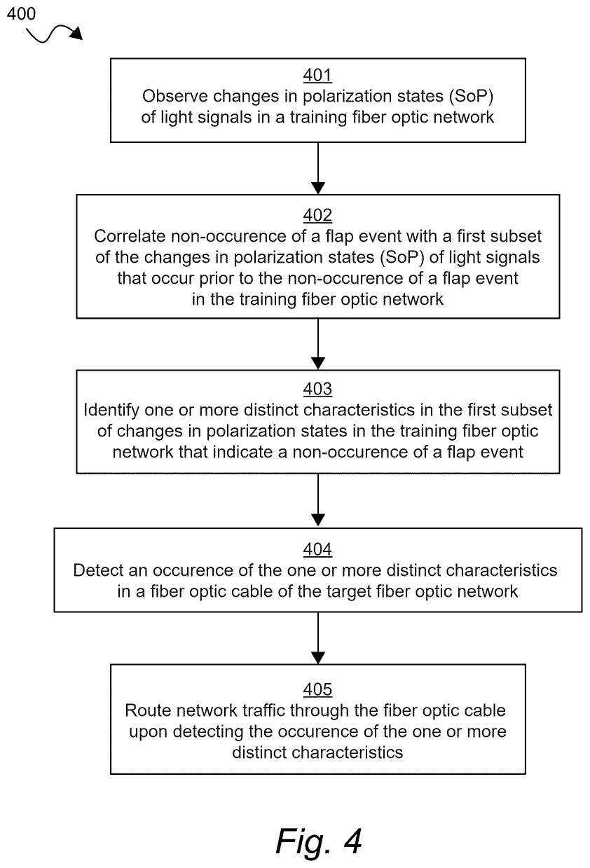

FIG. 4 shows another method 400 for improving performance and reliability of a target fiber optic network. Step 401 is to observe changes in polarization states (SoP) of light signals in a training fiber optic network. Step 402 is to correlate a non-occurrence of a flap event with a first subset of the changes in polarization states (SoP) of light signals that occur prior to the non-occurrence of the flap event in the training fiber optic network. Step 403 is to identify one or more distinct characteristics in the first subset of changes in polarization states in the training fiber optic network that indicate a non-occurrence of a flap event. Step 404 is to detect an occurrence of the one or more distinct characteristics in a fiber optic cable of the target fiber optic network. Step 405 is to route network traffic through the fiber optic cable upon detecting the occurrence of the one or more distinct characteristics. In this manner, fiber optic cables and pathways in the network are still utilized, despite the occurrence of changes in SoP.

It is also contemplated that the inventive principles disclosed herein can be used to detect specific causes of flap events for purposes of liability and for establishing best business practices. For example, a machine learning algorithm can be built and trained to identify whether a flap event was caused by a human (e.g., submarine, ship, maintenance) or a non-human (e.g., earthquake, severe weather, marine life activity) based on distinctive characteristics in the changes of SoP since each source has a unique stress signature. The source that causes the flap event can then be held liable for costs associated with the flap event and best business practices can be developed to reduce the occurrence of future flap events.

The inventive subject matter disclosed herein provides numerous advantages, such as the ability to forecast flap events and preemptively reroute network traffic, detecting third party maintenance events, detecting excessive movements along the fiber, and detecting mistreatment of fiber infrastructure.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary. The recitation of ranges of values herein is merely intended to serve as a shorthand method of referring individually to each separate value falling within the range. Unless otherwise indicated herein, each individual value within a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of improving performance and reliability of a target fiber optic network comprising:
observing changes in polarization states (SoP) of light signals in a training fiber optic network;
correlating flap events with a first subset of the changes in polarization states (SoP) of light signals that occur prior to the flap events in the training fiber optic network;
identifying one or more distinct characteristics in the first subset of changes in polarization states in the training fiber optic network that indicate an occurrence of a flap event;
detecting an occurrence of the one or more distinct characteristics in the target fiber optic network; and
rerouting network traffic in the target fiber optic network to preemptively avoid a flap event upon detecting the occurrence of the one or more distinct characteristics.

2. The method of claim 1, wherein the training fiber optic network and the target fiber optic network are the same.

3. The method of claim 1, further comprising the step of correlating non-occurrence of flap events with a second subset of changes in polarization states (SoP) of light signals in the training fiber optic network.

4. The method of claim 1, wherein the changes in polarization states (SoP) of light signals are caused by a physical movement of a fiber optic cable in the training fiber optic network.

5. The method of claim 4, wherein the physical disruption comprises one or more of a physical movement, a cut, a bending, a pulling, and a stretching.

6. The method of claim 1, further comprising the step of classifying the one or more distinct characteristics in the first subset of changes in polarization states in the training fiber optic network that indicate an occurrence of a flap event as either an environmental change or a maintenance task.

7. The method of claim 1, further comprising the step of using artificial intelligence (AI) to identify the one or more distinct characteristics in the first subset of changes in polarization states in the training fiber optic network that indicate an occurrence of a flap event.

8. The method of claim 1, further comprising the step of utilizing performance data to verify that the one or more distinct characteristics in the first subset of changes in polarization states in the training fiber optic network is indicative of an occurrence of a flap event.

9. The method of claim 8, wherein the performance data includes at least one of outage logs and packet drops.

10. The method of claim 1, further comprising the step of adjusting a maintenance schedule of either the target fiber optic network or a neighboring fiber optic network upon detecting the occurrence of the one or more distinct characteristics in the target fiber optic network.

11. The method of claim 1, further comprising the step of comparing a maintenance record of either the target fiber optic network or a neighboring fiber optic network with the changes in polarization states (SoP).

12. The method of claim 1, further comprising the step of mitigating the impact of long-term environmental changes on the training fiber optic network by rotating a Polarization's Stokes parameter of the light signals towards the north pole on the Poincaré sphere and employing a moving average within a 100-to-200 second timeframe.

13. The method of claim 12, further comprising the step of converting the rotated time series into frequency domain spectra.

14. The method of claim 13, further comprising the step of creating statistical models designed to identify physical events that impair network performance.

15. The method of claim 1, wherein the steps of detecting and rerouting are performed in real-time.

16. A method of improving performance and reliability of a target fiber optic network comprising:
observing changes in polarization states (SoP) of light signals in a training fiber optic network;
correlating non-occurrence of a flap event with a first subset of the changes in polarization states (SoP) of light signals that occur prior to the non-occurrence of the flap event in the training fiber optic network;
identifying one or more distinct characteristics in the first subset of changes in polarization states in the training fiber optic network that indicate a non-occurrence of a flap event;
detecting an occurrence of the one or more distinct characteristics in a fiber optic cable of the target fiber optic network; and
routing network traffic through the fiber optic cable upon detecting the occurrence of the one or more distinct characteristics.
